(19) United States
(12) Patent Application Publication
(10) Pub. No.: US 2024/0383137 A1
(43) Pub. Date: Nov. 21, 2024

(54) METHOD FOR COMPENSATING FOR POSITIONING INACCURACIES OF A LINEAR ROBOT, AND LINEAR ROBOT

(71) Applicant: linrob automation GmbH, Deggendorf (DE)

(72) Inventors: Andreas KÖCK, Deggendorf (DE); Rainer LOTT, Deggendorf (DE)

(21) Appl. No.: 18/693,882

(22) PCT Filed: Sep. 15, 2022
(86) PCT No.: PCT/EP2022/075590

§ 371 Date: Mar. 20, 2024

(30) Foreign Application Priority Data
Sep. 20, 2021 (DE) 10 2021 124 215.0

(51) Int. Cl. B25J 9/16; B25J 9/10

(52) U.S. Cl. CPC B25J 9/1641; B25J 9/10

(57) ABSTRACT

The invention relates to a method for compensating for positioning inaccuracies of a linear robot, which has a supporting and guiding structure having at least one a support rail with at least one linear guide and a carriage which can be moved on this rail by means of a motor, using a mathematical model of the supporting and guiding structure, which calculates geometric changes to the supporting and guiding structure on the basis of one or more parameters.

The invention relates to a method for compensating for positioning inaccuracies of a linear robot as well as a linear robot which includes a positioning compensation of this type.

Linear robots are generally known. They render possible automated movement sequences by moving along one or more straight traversing axes. Due to the combination of a plurality of traversing axes running at an angle to one another, it is possible to perform interlinked linear movements in space so that the linear robot can approach different positions in the three-dimensional space.

Linear robots which are known from the prior art usually use welded steel structures as support rails forming the traversing axes. Due to the complex manufacturing process, welded steel structures of this type have low accuracies so that the positioning accuracy of the linear robot is very low.

The accuracy of the welded steel structures can be improved by suitable post-processing, for example through stress-relief heat treatment and post machining. However, this renders the production very complex and therefore also expensive.

In addition, welded steel structures of this type always have an individual geometry so that it is always necessary to measure the supporting and guiding structure of the linear robot in order to be able to compensate for positional inaccuracies of the linear robot. Measurements of this type are also very expensive.

Taking this as a starting point, the object of the invention is to provide a method for compensating for positioning inaccuracies of a linear robot that renders possible a high positioning accuracy of the linear robot at simultaneously low cost.

This object is achieved by a method comprising the features of independent claim 1. A linear robot is the subject matter of further independent claim 10. Preferred embodiments are the subject matter of the subclaims.

According to a first aspect, the invention relates to a method for compensating for positioning inaccuracies of a linear robot. The linear robot comprises a supporting and guiding structure having at least one support rail with at least one linear guide and a carriage movable on this support rail by means of a motor. The support rail here preferably forms a traversing axis of the linear robot. The linear robot preferably has a plurality of support rails, which are coupled to one another in such a way that the linear robot can carry out translational motions along a plurality of axes of a Cartesian coordinate system at a mounting interface to which an actuator can be attached. For example, a second support rail, which forms a second traversing axis, can be fixed to a carriage which can be moved linearly on a first support rail that forms the first traversing axis. For example, the second traversing axis can accommodate a third support rail which forms a third traversing axis and which can be moved linearly on the second support rail by means of a second carriage.

The at least one support rail is formed by an extruded profile having a plurality of chambers. A control unit is provided in which a mathematical model of the supporting and guiding structure is implemented. The mathematical model calculates geometric changes to the supporting and guiding structure on the basis of one or more parameters. Depending on the calculations of the mathematical model, information with regard to the change in the geometric position and orientation of the mounting interface, to which an actuator can be attached, is determined on the basis of the change to one or more parameters. On the basis of the information with regard to the change in the geometric position and orientation of the mounting interface, the control unit carries out a change in the travel path of the carriage and/or a position change information for the actuator is provided at an actuator control interface, on the basis of which information the actuator can carry out a position change in order to be able to approach the desired target position despite the changed geometric properties of the supporting and guiding structure.

The technical advantage of the method is that a supporting and guiding structure having high accuracy and high reproducibility is created due to the use of an extruded profile as a support rail. This highly accurate and reproducibly manufacturable supporting and guiding structure makes it possible to calculate the parameter-dependent geometric changes to the supporting and guiding structure on a model basis, namely preferably without having to measure the linear robot. Due to this it is possible to minimize positioning inaccuracies caused by parameter-related changes to the geometry of the supporting and guiding structure of the linear robot, for example temperature changes, positions of the linear robot with a greater outreach or changed loads resulting from transporting an object through the actuator or changing the actuator to an actuator having a different weight.

According to one exemplary embodiment, the mathematical model comprises a plurality of splines that describe geometric changes to one or more components of the supporting and guiding structure on the basis of one or more parameters. The term “spline” refers to either a single polynomial of the nth degree or a piecewise polynomial curve comprising a plurality of polynomials. These splines are used to describe the parameter-dependent geometry of individual components of the supporting and guiding structure, a group of components of the supporting and guiding structure or the entire supporting and guiding structure. The splines can, for example, have been calculated on the basis of a finite element method. The change in the geometric position and orientation of the mounting interface is determined on the basis of the splines and the values of one or more parameters. By using the splines, it is possible to very quickly calculate the parameter-dependent geometric changes to the supporting and guiding structure iteratively with limited computing resources of a control unit of the linear robot so that position compensation can be carried out continuously as the parameters change.

According to one exemplary embodiment, the linear robot has a plurality of traversing axes that run at an angle to one another. These traversing axes are each formed by an extruded support rail. On the basis of the information with regard to the change in the geometric position and orientation of the mounting interface, the control unit calculates for each traversing axis a correction value, and the target position which shall be approached by the carriage moving on the respective traversing axis is modified on the basis of the correction value. As a result, it is possible to achieve a position compensation of the linear robot along a plurality of spatial axes.

According to one exemplary embodiment, the positioning inaccuracies caused by geometric changes to the supporting and guiding structure are compensated for by the interaction of the linear robot and the actuator fixed to the mounting interface in such a way that a first partial compensation is carried out by modifying the travel path of at least one carriage of the linear robot and a second partial compensation is carried out by modifying the positioning of a moving part of the actuator. For example, it is thus possible to compensate for a translational positioning deviation along one or more spatial axes by the linear robot and a positioning deviation caused by a rotation about a spatial axis by the actuator itself, which is for example an jointed-arm robot.

According to one exemplary embodiment, positioning inaccuracies are compensated for iteratively, namely in such a way that, on the basis of the mathematical model, information with regard to the change in the geometric position and orientation of the mounting interface is calculated successively in time on the basis of one or more parameters and, on the basis of the information with regard to the change in the geometric position and orientation of a mounting interface, a change in the travel path of the carriage is carried out and/or a position change information for the actuator is provided at an actuator control interface. As a result, it is possible to continuously compensate for the positioning inaccuracies during the operation of the linear robot and with changing parameters.

According to one exemplary embodiment, the parameters comprise external parameters that contain information with regard to the ambient temperature, humidity and/or weight of an object that is moved through the actuator. These parameters can be provided to the linear robot by a corresponding sensor system. It is thus possible to determine the geometric changes to the supporting and guiding structure on the basis of external parameters.

According to one exemplary embodiment, the parameters comprise machine parameters, i.e. parameters of the linear robot itself, which include information on the movement position of at least one carriage, the weight of the actuator and/or the current consumption of a motor. It is thus possible, for example, to determine the deflection of the supporting and guiding structure that results from the mechanical load at a certain outreach of the linear robot or due to the own weight of the actuator.

The actuator preferably transmits information on its current position or movement position to the control unit of the linear robot so that the position or movement position of the actuator can also be taken into account when compensating for the positioning inaccuracies.

According to one exemplary embodiment, a machine-learning method for processing the parameters is implemented in the control unit. On the basis of a plurality of parameters, the machine-learning method provides evaluation information. In particular e.g. one or more parameters can be used to evaluate another parameter. For example information of a temperature sensor can be combined with a sensor that measures solar radiation to recognize whether the temperature increase is a weather-related temperature increase or a temperature increase caused by the linear robot itself. Changing the travel path of the carriage and/or providing the position change information is carried out on the basis of the evaluation information. It is thus possible to make the compensation of the positioning inaccuracies not only dependent on the pure raw parameter values but also on derived information that is obtained by further processing a plurality of parameters by the machine-learning method.

According to one exemplary embodiment, a machine-learning method for processing the parameters is implemented in the control unit. The machine-learning method receives a plurality of parameters as input information and provides maintenance information by adaptively combining and adaptively evaluating the parameters. The adaptive combination or evaluation is based on the successive adaptation of weighting factors of the machine-learning system. It is thus possible to implement predictive maintenance that is not only dependent on the pure raw parameter values but also on derived information that is generated by further processing a plurality of parameters by the machine-learning method.

According to a further aspect, the invention relates to a linear robot. The linear robot comprises a supporting and guiding structure having at least one support rail with at least one linear guide and a carriage that can be moved on this support rail by means of a motor. The support rail here preferably forms a traversing axis of the linear robot. Preferably, the linear robot has a plurality of support rails that are coupled to one another in such a way that the linear robot can carry out at a mounting interface to which an actuator can be attached translational movements along a plurality of axes of a Cartesian coordinate system. In this way, it is possible to fix e.g. a second support rail, which forms a second traversing axis, to a carriage which can be moved linearly on a first support rail that forms the first traversing axis. For example, the second traversing axis can accommodate a third support rail which forms a third traversing axis and which can be moved linearly by means of a second carriage on the second support rail.

The support rail is formed by an extruded profile with a plurality of chambers. In particular, the support rail is an extruded aluminum profile. A control unit is provided which comprises a mathematical model of the supporting and guiding structure, by means of which geometric changes to the supporting and guiding structure can be calculated on the basis of one or more parameters. The control unit can be an individual control unit or can be formed by a group of interacting control modules. The supporting and guiding structure has a mounting interface to which an actuator can be attached. In particular, the actuator can be a jointed-arm robot. The mathematical model is designed to determine the change in the geometric position and orientation of the mounting interface on the basis of the change in one or more parameters. In addition, the control unit is designed to carry out a change to the travel path of the carriage on the basis of the information with regard to the change in the geometric position and orientation of the mounting interface.

According to one exemplary embodiment, a pair of linear guides is fixed on the support rail by means of screws, which are screwed into sliding blocks that are interlockingly inserted into grooves of the support rail. This makes it possible to achieve, without the need to drill holes, a highly accurate traversing axis which can be mounted so precisely that the parameter-related geometric change to the supporting and guiding structure can be predicted with sufficient accuracy by the mathematical model.

According to one exemplary embodiment, the linear guides are formed from extruded aluminum profiles that have steel inserts on which the linearly movable carriage is guided. This type of linear guides can be manufactured with high precision and reproducibility so that the parameter-dependent geometric changes to the linear guides and thus the entire supporting and guiding structure can be calculated on the basis of a model, namely preferably without measuring the supporting and guiding structure.

According to one exemplary embodiment, the carriage has an integrally cast support body made from cast iron. A carriage of this type has the advantage that the parameter-related geometric change thereof can be determined mathematically with high accuracy so that it is overall possible to be able to determine the parameter-dependent geometric changes to the entire supporting and guiding structure, which also includes the at least one carriage, with high accuracy on a model basis.

According to one exemplary embodiment, the linear robot has a plurality of traversing axes that run at an angle to one another. The control unit is designed to calculate for each traversing axis a correction value on the basis of the information with regard to the change in the geometric position and orientation of the mounting interface and to modify the target position to be approached by the carriage that is moved on the respective traversing axis on the basis of the correction value. As a result, it is possible to achieve a positioning compensation for the linear robot along a plurality of spatial axes.

According to one exemplary embodiment, the control unit has an actuator control interface where information regarding the position compensation is provided for the actuator that is attached to the mounting interface. This makes it possible to compensate for the position inaccuracies caused by the geometric change to the supporting and guiding structure by the interaction of the linear robot and the actuator fixed to the mounting interface in such a way that a first partial compensation is carried out by modifying the travel path of at least one carriage of the linear robot and a second partial compensation is carried out by modifying the positioning of a moving part of the actuator. In this way, e.g. a translational positioning deviation along one or more spatial axes can be compensated for by the linear robot and a positioning deviation which is generated by a rotation about a spatial axis can be compensated for by the actuator itself which is an articulated robot, for example.

The expressions “approximately”, “substantially” or “about” mean, in the sense of the invention, deviations from the respective exact value by +/−10%, preferably by +/−5% and/or deviations in the form of changes that are insignificant for the function.

Further developments, advantages and possible applications of the invention are also apparent from the following description of exemplary embodiments and from the drawings. Here, all the features described and/or illustrated, either individually or in any combination, are in principle a subject matter of the invention, irrespective of their summary in the claims or their back-reference. Furthermore, the content of the claims is also made part of the description.

The invention is explained in more detail below by way of exemplary embodiments on the basis of the drawings. In these drawings,

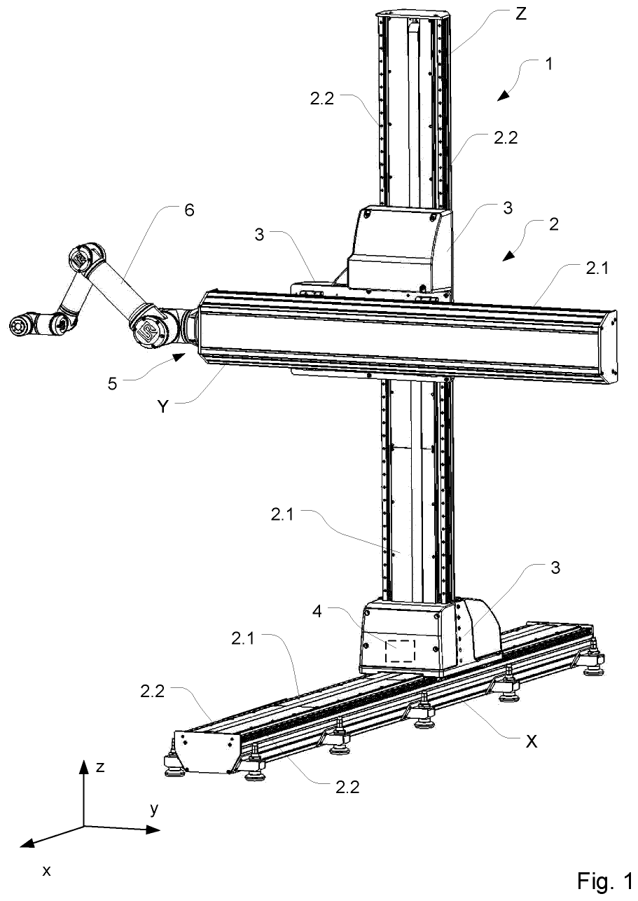

FIG. 1 shows, by way of example, a perspective view of an arrangement comprising a linear robot and a jointed-arm robot fixed to the linear robot as an actuator;

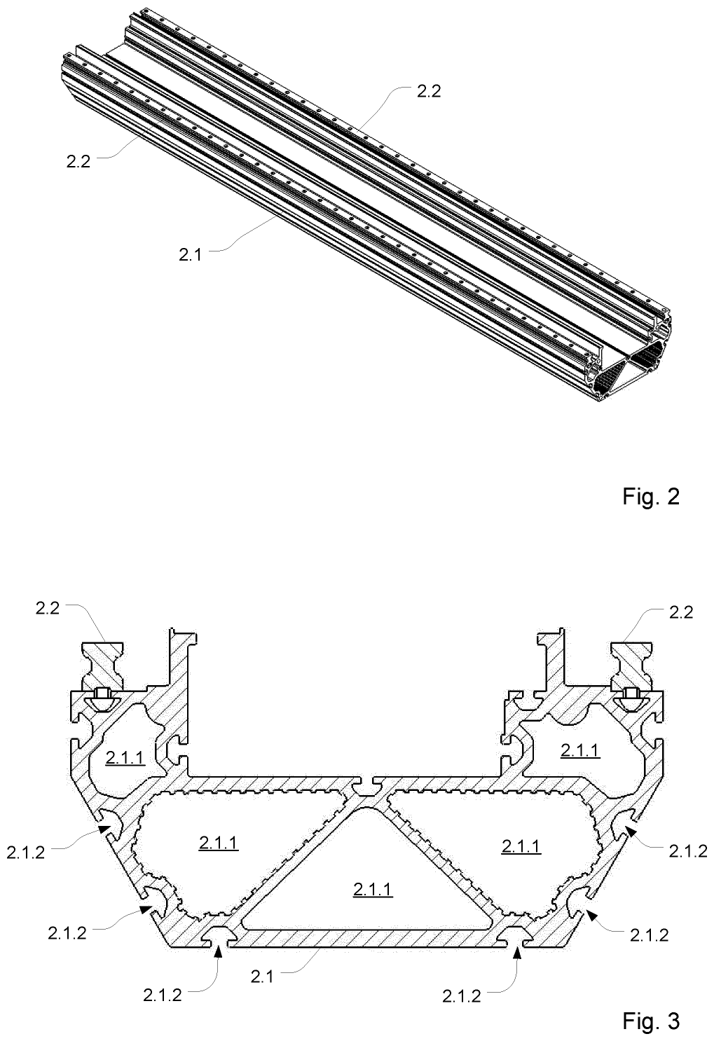

FIG. 2 shows, by way of example, a perspective view of a support rail for forming a traversing axis of the linear robot; and

FIG. 3 shows, by way of example, a sectional view of the support rail according to FIG. 2.

FIG. 1 shows by way of example an arrangement comprising a linear robot 1, to the mounting interface 5 of which an actuator 6 in the form of a jointed-arm robot is fixed. The advantage of an arrangement of this type is that it is possible to use a jointed-arm robot, the radius of action of which is considerably smaller than the travel paths of the linear robot 1, which increases the positioning accuracy, while the reach is increased by the linear robot 1 so that the arrangement of linear robot 1 and jointed-arm robot has a significantly larger range of action than the jointed-arm robot alone. In order to cover this range of action with a jointed-arm robot alone, a jointed-arm robot with a much greater arm length would be necessary, which would, however, lead to disadvantages in terms of positioning accuracy.

It should be noted that other types of actuators 6 can also be attached to the mounting interface 5, for example measuring devices, grippers, tools, such as brushes, spray nozzles, welding equipment, etc.

In the illustrated embodiment, the linear robot 1 has a supporting and guiding structure 2 with three axes that run at right angles to one another, namely an X-axis, a Y-axis and a Z-axis according to the Cartesian coordinate system shown in FIG. 1. In the illustrated exemplary embodiment, the X-axis of the linear robot 1 is mounted on a set-up area, the Z-axis is angled upwards away from this X-axis, and the Y-axis is again held at right angles at the Z-axis.

It is understood that the linear robot 1 can have more or fewer axes, depending on the application. In addition, the linear robot 1 can be fixed in a different way, for example on a vertical wall or also be suspended, i.e. in this case, the X-axis of the linear robot 1 would be fixed to a ceiling and the Z-axis would project downwards from this X-axis.

The X-, Y- and Z-axes are each formed by a support rail 2.1. On the support rails 2.1, one carriage 3 each is provided which can be moved along the longitudinal axis of the respective support rail 2.1 by means of a motor in order to achieve in this way an adjustment in the respective axis direction along which the respective support rail 2.1 runs. In this way, it is possible to adjust the mounting interface 5 and thus also the actuator 6 attached thereto by means of the X-, Y- and Z-axes of the linear robot 1 in the x-, y- and z-directions. It should be noted that on one axis, e.g. the X-axis, more than one carriage 3 and thus shiftably guided axes can be provided, which can be moved and compensated for independently of one another. In addition, at least some of the axes can be rotatably mounted on the carriage 3 in such a way that the axes can be rotated about the longitudinal axes thereof.

The support rail 2.1 is shown individually and in section in FIGS. 2 and 3, respectively. According to the invention, the support rail 2.1 is formed from an extruded profile which has a plurality of chambers 2.1.1 and webs forming these chambers 2.1.1 or stiffening the support rail 2.1. The extruded profile is preferably an extruded aluminum profile. The advantage of the extruded profile is that it can be manufactured with high precision, in a repeatable manner and homogeneously so that the change in the geometry of the support rail 2.1 can be determined with high accuracy by means of a mathematical model on the basis of parameters.

On the outside, the support rail 2.1 has a plurality of grooves 2.1.2, which run in the longitudinal direction of the support rail 2.1. It is possible to insert, into these grooves 2.1.2., sliding blocks which have an internal thread so that the support rail 2.1 can therefore be mounted on a set-up area or attachment parts can be fixed to the support rail 2.1 itself.

In order to be able to guide a carriage on the respective support rail 2.1, a pair of linear guides 2.2 is provided on the support rail 2.1. The linear guides 2.2 form a guide slot in which guide elements of the carriage 3 are guided.

The linear guides 2.2 are preferably also extruded aluminum profiles and have steel inserts on which the carriage 3 is guided. As a result, the linear guides 2.2 can be manufactured in a highly accurate, repeatable and homogeneous manner so that the change in the geometry of the linear guides 2.2 can again be determined with high accuracy on the basis of parameters by a mathematical model.

The linear guides 2.2 are preferably screwed onto the support rail 2.1, it being again preferable to use a screw connection by means of sliding blocks which are inserted into top grooves 2.1.2 of the support rail 2.1.

It is described below how to carry out a compensation for positioning inaccuracies of the mounting interface 5 or a tool of an actuator 6, which can be a jointed-arm robot, for example, in order to render possible the most accurate approach of a desired position, i.e. to keep the deviation of the actual position, at which the mounting interface 5 or the tool of the actuator 6 is located, from the desired target position as small as possible.

The supporting and guiding structure 2 of the linear robot 1, i.e. the arrangement of structural parts between a mounting surface, for example the floor, the wall, the ceiling, etc., and the mounting interface 5 is described by a mathematical model. The mathematical model indicates in particular how the geometry of the supporting and guiding structure 2 of the linear robot 1 changes on the basis of one or more parameters. These changes can, for example, result from thermal expansions, deflection, torsion, twisting, etc.

The parameters can, for example, represent external influences, such as the ambient temperature, humidity or the weight of an object moved by the actuator or parameters of the linear robot 1 or the actuator 6 itself, for example information about the movement position of one or more carriages 3, the weight of the actuator 6, the movement position of the actuator or the current consumption of a motor.

Since parameters of this type have an influence on the geometry of the supporting and guiding structure 2 of the linear robot 1, these parameters are provided to the mathematical model as input variables in order to calculate the change in the geometry of the supporting and guiding structure 2 on the basis of the mathematical model. This change in the geometry creates a change in the position or orientation of the mounting interface so that depending on the respective parameters the actuator 6 is no longer located at the desired target position but at an actual position which, on the basis of the degree of the geometry change to the supporting and guiding structure 2, differs from the target position.

The mathematical model of the supporting and guiding structure 2 indicates which geometric change in the area of the mounting interface 5 is obtained on the basis of one or more parameters. For example, the mathematical model can be used to determine which deflection or torsion occurs in the supporting and guiding structure 2 when e.g. the Y-axis of the linear robot 1 is moved in such a way that the actuator 6 is moved from a more central position in the area of the Z-axis to a position that is farther away from the Z-axis, which, for example, results in a greater deflection of the Y- and Z-axes. Furthermore, the mathematical model can, for example, indicate the position change which is obtained due to a change in the ambient temperature as a result of the changed material expansion.

The mathematical model can, for example, be based on a finite element method.

In order to be able to carry out a prompt recalculation of the geometric changes to the supporting and guiding structure 2 in the case of rapid parameter changes, it is preferred not to carry out a recalculation for each iteration step according to the finite element method. Instead, a simplified mathematical model is generated on the basis of the finite element method, which model can be calculated with less computing power. The simplified mathematical model comprises a plurality of splines (i.e. functional descriptions in the form of polynomials of the nth order) that indicate which geometric changes occur on the basis of one or more parameters.

On the basis of this simplified mathematical model, it is possible to carry out a calculation of the geometry changes to the supporting and guiding structure 2 and thus a compensation for positioning inaccuracies even in the case of rapid parameter changes.

In order to compensate for the parameter-related geometry changes to the supporting and guiding structure 2 and thus the deviation between the actual position and the target position of the mounting interface 5 or the end effector of the actuator 6, the linear robot 1 has a control unit 4. In this control unit 4, the calculation of the parameter-related geometry changes is preferably carried out on the basis of the mathematical or simplified mathematical model. In addition, the control unit 4 is designed to adapt the travel paths of the linear robot 1 in such a way that the mounting interface 5 or the end effector of the actuator 6 approaches the target position as precisely as possible.

Due to the exclusively linear movability of the carriages 3, only a compensation by a modified linear movement is possible, i.e. the movement of the carriage along the respective traversing axis can be shorter or longer.

In order to also be able to carry out a further compensation for the position inaccuracies by the actuator 6 itself, which is fixed to the mounting interface 5, the control unit 4 preferably comprises an actuator control interface. This actuator control interface can be an OPC/UA or ETHERCAT interface, for example. Via this actuator control interface, it is possible to transmit correction information to the actuator 6 so that the actuator 6 can carry out a modified movement on the basis of the correction information in order to compensate for the positioning inaccuracies.

It is understood that an overall compensation for the positioning inaccuracies can also be carried out by means of a compensation that is distributed over the linear robot 1 and the actuator 6, i.e. a first partial compensation is carried out by the linear robot 1 and a second partial compensation is realized by the actuator 6, the first and second partial compensations complementing each other in such a way that the desired total compensation is thus achieved.

Furthermore, the compensation for the positioning inaccuracies can be achieved in such a way that the overall compensation is carried out by the actuator 6, i.e. there is no compensation on the linear robot 1 itself but the entire correction information required for the compensation is transmitted to the actuator 6 via the actuator control interface so that it alone can bring about the overall compensation.

In a preferred embodiment, the control unit 4 implements a machine-learning algorithm, which is realized, for example, by an artificial neural network. The machine-learning algorithm receives a plurality of parameters. The parameters can, for example, be parameters that are required by the mathematical model to compensate for positioning inaccuracies. However, further parameters can also be received additionally by the machine-learning algorithm, which parameters are not directly required to compensate for positioning inaccuracies, but for example for the purpose of machine monitoring or predictive maintenance. The machine-learning algorithm can be designed to process the information with regard to the respective parameters or correlate them with one another in order to recognize correlations between the parameters and to initiate actions on the basis of the recognized correlations.

In this case, the action can, for example, be that, when compensating for the positioning inaccuracies, it is not the parameter values provided by the sensors or other units which are directly considered but rather initial information from the machine-learning algorithm, which is obtained on the basis of a combination of a plurality of parameters or information.

Alternatively or additionally, it is also possible to combine and thus evaluate a plurality of parameters with one another by the machine-learning algorithm in order to generate maintenance information by the control unit. In this way, e.g. the combination of vibrations that occur during the movement of the linear robot 1, which is also accompanied by increased power consumption of the motor that initiates the movement, may indicate that there is e.g. damage to a bearing or linear guide, whereas, e.g. a merely higher power consumption of the motor is not in itself an indication of damage and therefore does not trigger the generation of maintenance information.

The machine-learning algorithm can here adaptively adjust the weighting factors, on the basis of which the parameters are combined so that the algorithm gradually modifies the way in which the parameters are correlated with one another.

It has already been noted above that it is also possible to provide one axis, for example the X-axis, with more than one carriage 3 and thus more than one slidably guided axis, which can be moved and compensated for independently of one another. In other words, the linear robot 1 therefore has two or more partial areas that can be moved independently of one another (for example, consisting of a Z-axis and/or a Y-axis), which are slidably guided on a common part of the supporting and guiding structure 2, for example on a common X-axis,

The two partial areas of the linear robot 1 that can be moved independently of one another can each have an independent control unit, each control unit taking over the control of and compensation for the respective associated partial area of the linear robot 1. The compensation for one part of the linear robot 1 can here be carried out independently of the compensation for at least one further part of the linear robot 1.

In the event that a mechanical coupling of the two partial areas of the linear robot 1 can be expected by the common part of the supporting and guiding structure 2, the compensation carried out by the control unit of a first partial area of the linear robot 1 can be carried out on the basis of parameters of the second partial area of the linear robot 1. In order to render possible an interdependent compensation, i.e. coupled compensation, of the two partial areas, either communication can take place between the respective control units themselves or the control units can be coupled with a higher-level control unit. The higher-level control unit could in this case provide the information required for the coupled compensation to the respective control unit of the partial areas of the linear robot 1.

The invention has been described above by means of exemplary embodiments. It is understood that numerous changes and modifications are possible without departing from the scope of protection defined by the claims.

### LIST OF REFERENCE SIGNS

1 linear robot
2 supporting and guiding structure
2.1 support rail
2.1.1 chamber
2.1.2 groove
2.2 linear guide
3 carriage
4 control unit
5 mounting interface
6 actuator
X first traversing axis
Y second traversing axis
Z third traversing axis

1. A method for compensating for positioning inaccuracies of a linear robot, which includes a supporting and guiding structure having at least one support rail with at least one linear guide and a carriage which can be moved on this support rail by means of a motor, wherein the support rail is formed by an extruded profile with a plurality of chambers, wherein a control unit is provided, in which a mathematical model of the supporting and guiding structure is implemented, wherein the mathematical model calculates geometric changes to the supporting and guiding structure on the basis of one or more parameters, and wherein, on the basis of the mathematical model, information with regard to the change in the geometric position and orientation of a mounting interface to which an actuator can be attached, is determined on the basis of the change in one or more parameters, and wherein, on the basis of the information with regard to the change in the geometric position and orientation of the mounting interface, the control unit carries out a change to the travel path of the carriage or provides an actuator control interface with position change information for the actuator.

2. The method according to claim 1, wherein the mathematical model comprises a plurality of splines which describe geometric changes to one or more components of the supporting and guiding structure on the basis of one or more parameters and wherein, on the basis of the splines and the values of one or more parameters, the change in the geometric position and orientation of the mounting interface is determined.

3. The method according to claim 1, wherein the linear robot has a plurality of traversing axes running at an angle to one another and wherein, on the basis of the information with regard to the change in the geometric position and orientation of the mounting interface, the control unit calculates for each traversing axis a correction value, and the target position which must be approached by the carriage moving on the respective traversing axis is modified on the basis of the correction value.

4. The method according to claim 1, wherein the position inaccuracies are compensated for by interaction between the linear robot and the actuator fixed to the mounting interface in such a way that a first partial compensation is achieved by modifying the travel path of at least one carriage of the linear robot and a second partial compensation is achieved by modifying the positioning of a moving part of the actuator.

5. The method according to claim 1, wherein positioning inaccuracies are compensated for iteratively in such a way that, on the basis of the mathematical model, information with regard to the change in the geometric position and orientation of the mounting interface is calculated successively in time on the basis of one or more parameters and, on the basis of the information with regard to the change in the geometric position and orientation of a mounting interface, a change in the travel path of the carriage is carried out or position change information for the actuator is provided at an actuator control interface.

6. The method according to claim 1, wherein the parameters comprise external parameters which include information with regard to the ambient temperature, humidity or weight of an object moved by the actuator.

7. The method according to claim 1, wherein the parameters comprise machine parameters including information on the movement position of at least one carriage, the weight of the actuator or the current consumption of a motor.

8. The method according to claim 1, wherein a machine-learning method for processing the parameters is implemented in the control unit, wherein the machine-learning method provides evaluation information on the basis of a plurality of parameters, and wherein the change in the travel path of the carriage or the provision of the position change information is carried out on the basis of the evaluation information.

9. The method according to claim 1, wherein a machine-learning method for processing the parameters is implemented in the control unit, and wherein the machine-learning method receives a plurality of parameters as input information and provides maintenance information by adaptive combination and adaptive evaluation of the parameters.

10. A linear robot comprising a supporting and guiding structure having at least one support rail with at least one linear guide and a carriage which can be moved on this support rail by means of a motor, wherein the support rail is formed by an extruded profile with a plurality of chambers, wherein a control unit is provided which has a mathematical model of the supporting and guiding structure, by means of which geometric changes to the supporting and guiding structure can be calculated on the basis of one or more parameters, wherein the supporting and guiding structure comprises a mounting interface to which an actuator can be attached, wherein the mathematical model is designed to determine the change in the geometric position and orientation of the mounting interface on the basis of the change in one or more parameters, and wherein the control unit is configured to carry out, on the basis of the information with regard to the change in the geometric position and orientation of the mounting interface, a change in the travel path of the carriage.

11. The linear robot according to claim 10, wherein a pair of linear guides is fixed on the support rail, namely by means of screws which are screwed into sliding blocks which are interlockingly introduced into grooves of the support rail.

12. The linear robot according to claim 11, wherein the linear guides are formed from extruded aluminum profiles which comprise steel inserts on which the linearly movable carriage is guided.

13. The linear robot according to claim 10, wherein the carriage comprises an integrally cast supporting body made of cast iron.

14. The linear robot according to claim 10, wherein the linear robot comprises a plurality of traversing axes which run at an angle to one another, and wherein the control unit is configured, on the basis of the information with regard to the change in the geometric position and orientation of the mounting interface, to calculate for each traversing axis a correction value and to modify the target position which must be approached by the carriage moving on the respective traversing axis, on the basis of the correction value.

15. The linear robot according to claim 10, wherein the control unit comprises an actuator control interface, at which information with regard to the position compensation for the actuator attached to the mounting interface is provided.
